(19) United States
(12) Patent Application Publication
(10) Pub. No.: US 2015/0124130 A1
(43) Pub. Date: May 7, 2015

(54) IMAGE SENSOR

(71) Applicant: Himax Imaging, Inc., Grand Cayman (KY)

(72) Inventor: Ping-Hung Yin, Grand Cayman (KY)

(73) Assignee: Himax Imaging, Inc., Grand Cayman (KY)

(21) Appl. No.: 14/207,664

(22) Filed: Mar. 13, 2014

(30) Foreign Application Priority Data
Nov. 1, 2013 (TW) 102139833

(51) Int. Cl. H04N 5/378

(52) U.S. Cl. CPC H04N 5/378
USPC 348/294

(57) ABSTRACT

An image sensor includes a passive pixel sensor array and a readout circuit. The passive pixel sensor array has a plurality of pixel columns each having at least one column line. The readout circuit includes a ramp signal generating circuit, a ramp signal line and a comparing circuit. The ramp signal generating circuit is arranged for generating a ramp signal. The ramp signal line is arranged for receiving the ramp signal, wherein the ramp signal line intersects the column line without electrical connection so as to form a parasitic capacitor. The comparing circuit corresponds to the column lines, wherein during the operating cycle of the readout circuit, a pixel sensor of the passive pixel sensor array outputs a charge signal to the column line, and the comparing circuit is arranged for generating an output signal of the pixel sensor according to the ramp signal and the charge signal.

### BACKGROUND OF THE INVENTION

1. Field of the Invention

The present invention relates to image sensing, and more particularly, to an image sensor using comparators instead of operational amplifiers at output stage to provide low readout noise for passive pixel architecture.

2. Description of the Prior Art

Please refer to FIG. 1, which is a schematic diagram illustrating an exemplary example of a traditional image sensor 100 for a passive pixel sensor array 10. In FIG. 1, the readout circuit 100 includes a plurality of column circuits 110-120, and each of the plurality of column circuits 110-120 includes an operational amplifier and a capacitor. For example, column circuit 110 includes an operational amplifier 112 and a capacitor 114, and column circuit 120 includes an operational amplifier 122 and a capacitor 124. The pixel sensor array 10 includes a plurality of pixel sensors P11-P24, and each of the plurality of pixel sensors P11-P24 is coupled to the associated readout circuit 100 via a signal line 116 or 126, each has a small parasitic capacitor. For each column circuit, the coupled parasitic capacitors may be expressed by an equivalent capacitance Cp.

Due to the demand of high resolution of image sensors, the pixels are designed to be smaller, therefore, the capacitor 114 has to be as small as capacitance Cp to yield enough output swing to overcome readout noise caused by the operational amplifier 112. However, this will raise production cost and the readout noise still persists.

Therefore, there is a need for a readout circuit for a passive pixel sensor providing low readout noise.

### SUMMARY OF THE INVENTION

In accordance with exemplary embodiments of the present invention, a readout circuit using comparators at output stage to provide low readout noise for passive pixel architecture is proposed to solve the above-mentioned problem.

According to an aspect of the present invention, an exemplary image sensor is disclosed. The exemplary image sensor includes a passive pixel sensor array and a readout circuit. The passive pixel sensor array has a plurality of pixel columns each having at least one column line. The readout circuit includes a ramp signal generating circuit, a ramp signal line and a comparing circuit. The ramp signal generating circuit is arranged for generating a ramp signal during an operating cycle of the readout circuit. The ramp signal line is arranged for receiving the ramp signal, wherein the ramp signal line intersects the column line without electrical connection so as to form a parasitic capacitor between the ramp signal line and the column line. The comparing circuit corresponds to the column lines, wherein during the operating cycle of the readout circuit, a pixel sensor of the passive pixel sensor array outputs a charge signal to the column line, and the comparing circuit is arranged for generating an output signal of the pixel sensor according to the ramp signal and the charge signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an exemplary example of a traditional image sensor for a passive pixel sensor array.

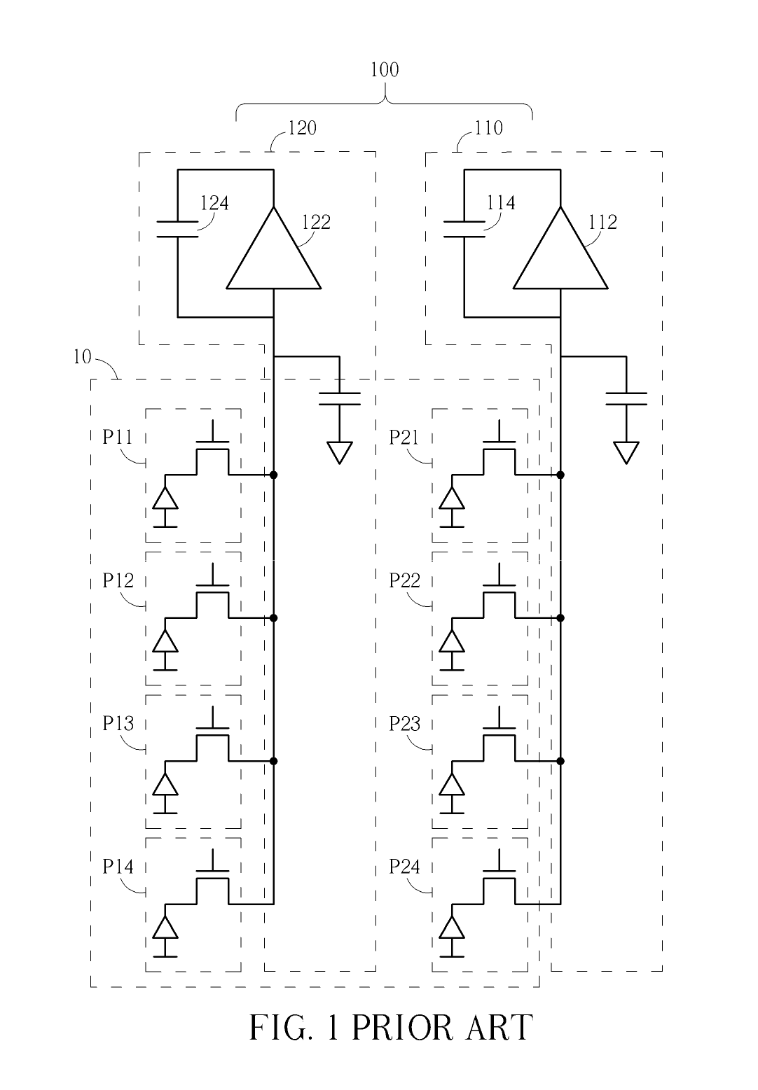

FIG. 2 is a schematic diagram illustrating an image sensor according to a first embodiment of the present invention.

FIG. 3 is a schematic diagram illustrating an image sensor according to a second embodiment of the present invention.

FIG. 4 is a timing diagram illustrating operations of the image sensor in FIG. 2.

FIG. 5 is a timing diagram illustrating operations of the image sensor in FIG. 3.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

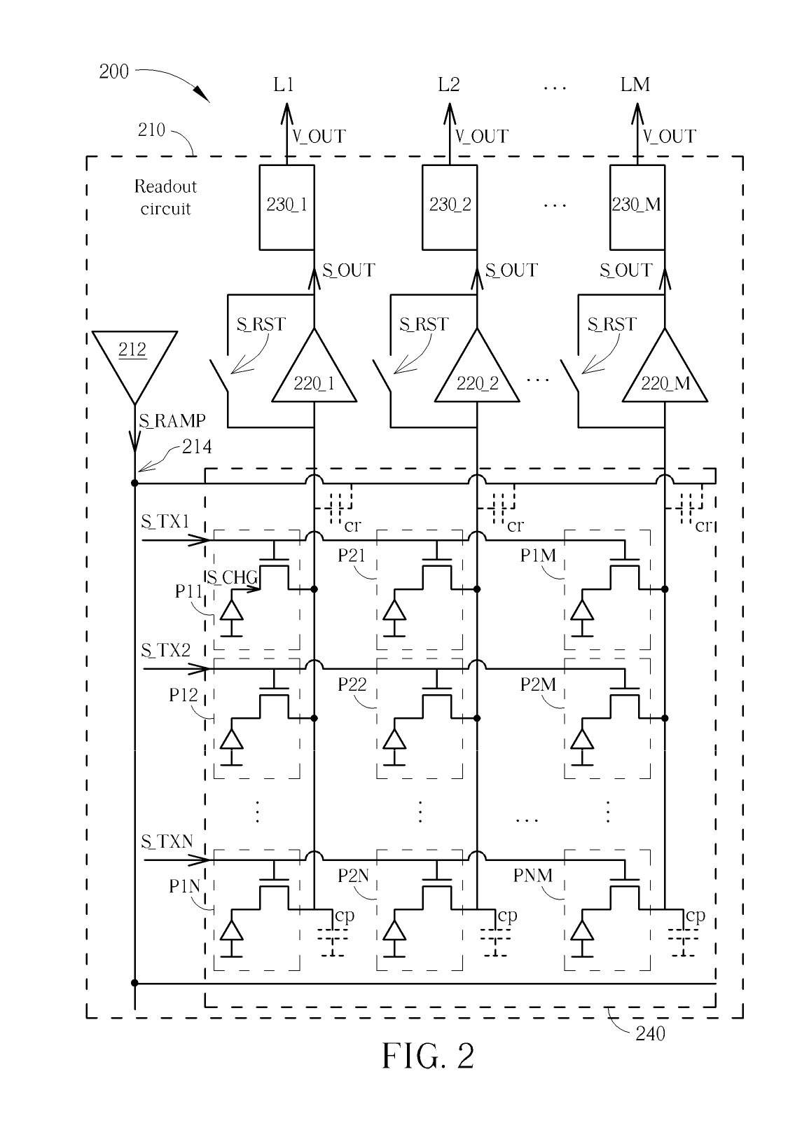

Please refer to FIG. 2, which is a schematic diagram illustrating an image sensor 200 according to a first embodiment of the present invention. The image sensor 200 includes a readout circuit 210 and a passive pixel sensor array 240. In this embodiment, the passive pixel sensor array 240 is a MxN pixel sensor matrix, having a plurality of column lines L1-LM, and each of the plurality of column lines L1-LM is coupled to a plurality of pixel sensors. That is, each pixel sensor in the pixel sensor array 240 is coupled to one column line via a floating diffusion of that pixel sensor, and the floating diffusion of each pixel sensor forms a parasitic capacitor. For example, pixel sensors P11-P1N are coupled to the column line L1, and the parasitic capacitors caused by the floating diffusions of the pixel sensors P11-P14 on the column line L1 may be accumulated and expressed by an equivalent capacitance Cp. Each pixel sensor in the same row of the pixel sensor array 240, e.g., pixel sensors P11-PM1, is controlled by a control signal, e.g., signal S_TX1, via a transfer gate of that pixel sensor. For example, when the control signal S_TX1 indicates a transfer gate of pixel sensor P11 to be opened, the pixel sensor P11 transfers a charge signal S_CHG to the floating diffusion of pixel sensor P11.

The readout circuit 210 includes, but not limited to, a ramp signal generating circuit 212, a ramp signal line 214, a plurality of comparing circuit 220_1-220_M and a plurality of counters 230_1-230_M. The ramp signal generating circuit 212 is arranged for generating a ramp signal S_RAMP during an operating cycle of the readout circuit 210. The ramp signal line 214 is arranged for receiving the ramp signal S_RAMP and intersects the column line without electrical connection so as to form a parasitic capacitor between the ramp signal line 214 and the column line L1-LM. The ramp signal generating circuit 212 transmits the ramp signal S_RAMP via the ramp signal line 214. Take column line L1 for example, the ramp signal line 214 overlays/crosses but is not directly electrically connected to the column line L1, thereby inducing an inductive capacitor Cr at the intersection between the ramp signal line 214 and the column line L1.

The comparing circuits 220_1-220_M are coupled to the plurality of column lines L1-LM, respectively. The comparing circuits 220_1-220_M receives the ramp signal S_RAMP via the parasitic capacitor Cr from ramp signal generating circuit 212 as well, and during an operating cycle of the readout circuit 210, a pixel sensor of the passive pixel sensor array 240 outputs the charge signal S_CHG to a column line of the plurality of column lines L1-LM, and each of the comparing circuits L1-LM is arranged for generating an output signal S_OUT of the pixel sensor according to the ramp signal S_RAMP and the charge signal of the corresponding column line. For example, the comparing circuits L1 may be responsible for generating an output signal S_OUT of a pixel sensor P11 to the column L1 according to the charge signal S_CHG of the column line L1 and the ramp signal S_RAMP during the operating cycle of the readout circuit 210. Specifically, the state of the output signal S_OUT is altered once the ramp signal S_RAMP exceeds the charge signal S_CHG of the column line L1. In addition, the plurality of counters 230_1-230_M are coupled to the comparing circuits 220_1-220_M, respectively, and each of the plurality of counters is arranged for counting a time period T that the output signal S_OUT takes to alter its state, and accordingly generating a readout value V_OUT.

In short, by way of example, but not limitation, the operations of the readout circuit 210 may be summarized as the following step. First, during the operating cycle of the readout circuit, the comparing circuits 220_1 and the counter 230_1 are reset. Second, the control signal S_TX1 is asserted to make the pixel sensor P11 transfers the charge signal S_CHG of the photodiode to the floating diffusion of the pixel sensor P11. Then after the pixel sensor P11 transfers the charge signal S_CHG, the ramp signal generating circuit 212 generates the ramp signal S_RAMP. Next, the comparing circuit 220_1 compares a voltage level of the ramp signal S_RAMP (manifested by the inductive capacitor Cr) and a voltage level of transferred charges (manifested by the capacitance Cp). When the ramp signal S_RAMP reaches the voltage level of transferred charges, the voltage level of the output signal S_OUT drops. The counter 230_1 outputs the time period T before the ramp signal S_RAMP reaches the voltage level of transferred charges as the readout value V_OUT of the pixel sensor P11.

In addition, since the capacitance Cp is contributed by several of the floating diffusions of the pixel sensors, it is only reasonable to generate the output signal S_OUT of each of the pixel sensors by using the same ramp signal S_RAMP. That is, the ramp signal S_RAMP with a same waveform may be assigned to several rows of the pixel sensor array 240. For example, if the capacitance Cp is contributed by the floating diffusions of the pixel sensors P11-P14, the same ramp signal S_RAMP used to generate the output signal S_OUT of the pixel sensor P11 will also be used to generate the output signal S_OUT of the pixel sensor P12, P13 and P14. The reason why the capacitance Cp needs to be contributed by several donors is that the capacitance Cp should be controlled at the same order of the capacitor Cr for this readout architecture to work optimally. If the capacitance Cp is far smaller than the capacitor Cr, output swing of the readout circuit 210 is very likely to be truncated too much. On the other hand, if the capacitance Cp is far larger than the capacitor Cr, the readout speed of the readout circuit 210 will be compromised. The latter issue may be addressed by partitioning the pixel sensor array 240.

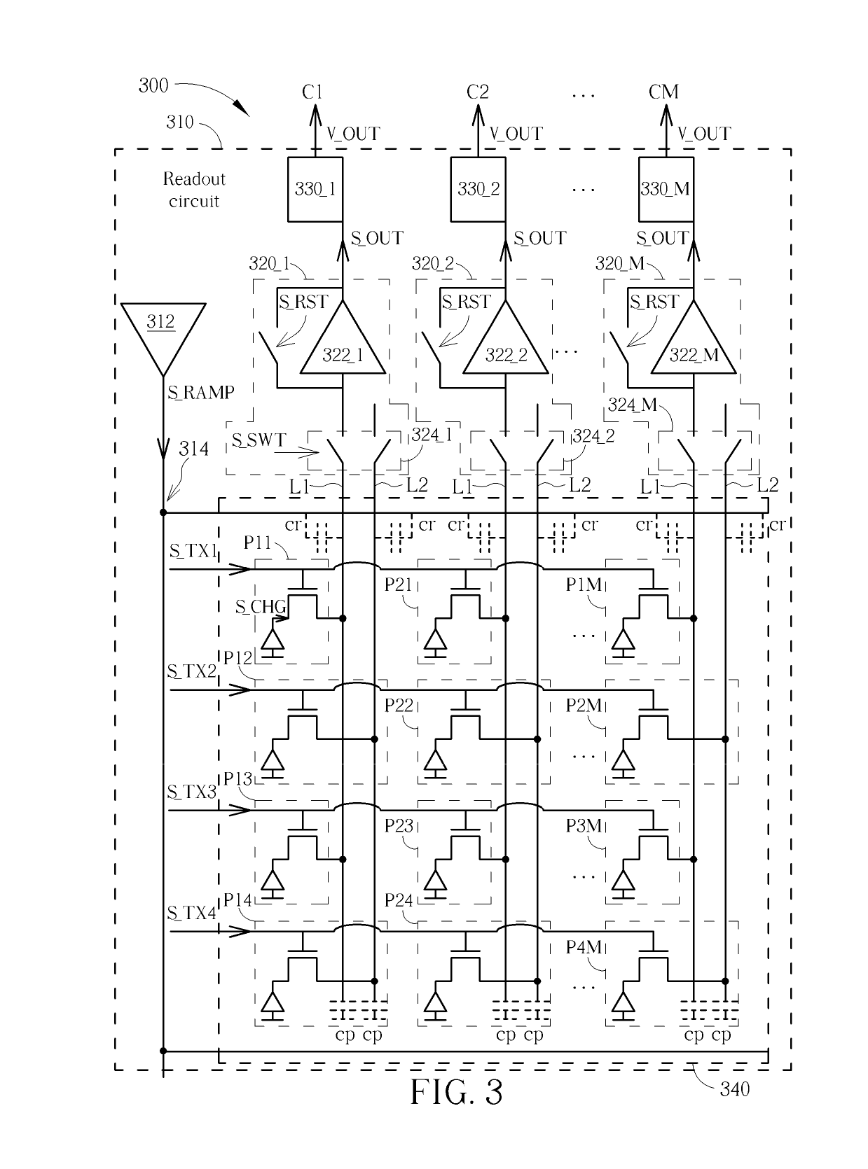

By way of example, but not limitation, please refer to FIG. 3, which is a schematic diagram illustrating a image sensor 300 according to a second embodiment of the present invention. In this embodiment, the passive pixel sensor array 340 is a M×N pixel sensor matrix, having a plurality of columns C1-CM each having two column lines L1 and L2, and each column line of the plurality of column C1-CM is coupled to half of a plurality of pixel sensors corresponding to the same column. For example, pixel sensors (e.g., P11, P13, . . . ) in the odd-numbered rows of the pixel sensor array 340 are coupled to the column line L1 of column C1 while pixel sensors (e.g., P12, P14, . . . ) in the even-numbered rows of the pixel sensor array 340 are coupled to the column line L2 of column C1. This way, the capacitance Cp in the pixel sensor array 340 may be reduced to half of that in the pixel sensor array 240.

The structure of the image sensor 300 is substantially the same with that of image sensor 200. The main difference is that each of the comparing circuits 320_1-320_M further includes a switch for selectively coupling the corresponding column line, selected from the column lines of a corresponding pixel column, to a comparator thereof. For example, the comparing circuit 320_1 includes a switch 324_1 to selectively couple the column lines L1 or L2 of the column C1 to the comparator 322_1. The switch 324_1 couples one of the column lines L1 and L2 of the column C1 to the comparator 322_1 before the ramp signal generating circuit 310 generates the ramp signal S_RAMP. As a person skilled in the art can readily understand the operation of the image sensor 300 after reading above paragraphs directed to the image sensor 200, further description is omitted here for brevity.

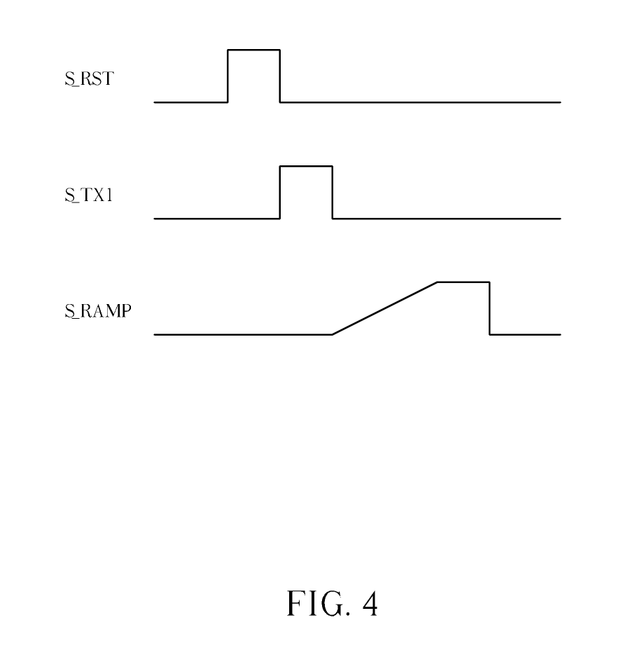

Please refer to FIG. 4, which is a timing diagram illustrating operations of the image sensor 200 in FIG. 2. By way of example, but not limitation, FIG. 4 illustrates operations of the image sensor 200 reading out data from the pixel sensor P11. The signal S_RST is used for resetting the comparing circuit 220_1, the signal S_{—} TX1 is used for controlling the transfer gate of the pixel sensor P11, and the ramp signal S_RAMP is used for pulling up the voltage level of the inductive capacitor Cr. As a person skilled in the art can readily understand relationship between signals shown in FIG. 4 after reading the above paragraphs directed to the image sensor 200, further description is omitted here for brevity.

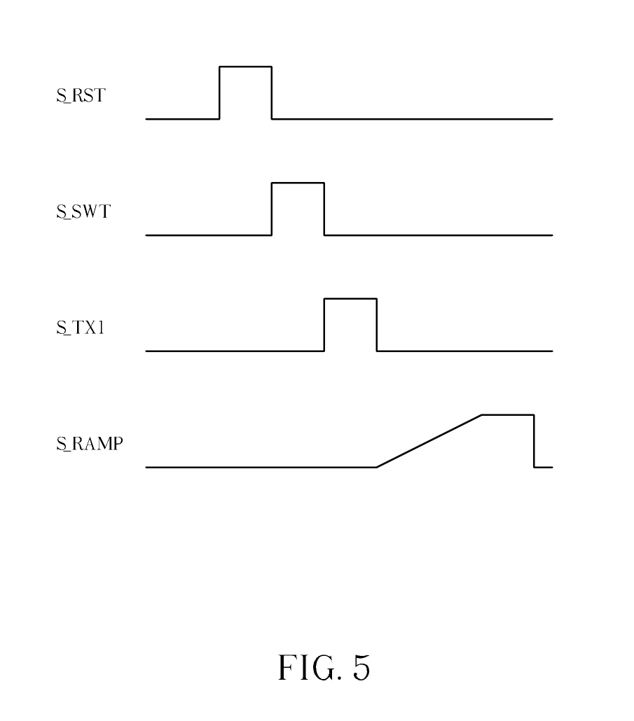

Please refer to FIG. 5, which is a timing diagram illustrating operations of the image sensor 300 in FIG. 3. By way of example, but not limitation, FIG. 5 illustrates operations of the image sensor 300 reading out data from the pixel sensor P11. The signal S_SWT is used to selectively connect the comparator 322_1 to the column line L1 of column C1 or connect the comparator 322_1 to the column line L2 of column C1, the signal S_RST is used for resetting the comparing circuit 220_1, the signal S_{—} TX1 is used for controlling the transfer gate of the pixel sensor P11, and the ramp signal S_RAMP is used for pulling up the voltage level of the inductive capacitor Cr. As a person skilled in the art can readily understand relationship between signals shown in FIG. 5 after reading the above paragraphs directed to the image sensor 300, further description is omitted here for brevity.

In conclusion, the present invention uses comparators instead of operational amplifiers at output stage to provide low readout noise for passive pixel architecture.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image sensor comprising:
a passive pixel sensor array having a plurality of pixel columns each having at least one column line; and
a readout circuit comprising:
a ramp signal generating circuit, for generating a ramp signal during an operating cycle of the readout circuit; and
a ramp signal line for receiving the ramp signal, wherein the ramp signal line intersects the column line without electrical connection so as to form a parasitic capacitor between the ramp signal line and the column line;
a comparing circuit, corresponding to the column lines, wherein during the operating cycle of the readout circuit, a pixel sensor of the passive pixel sensor array outputs a charge signal to the column line, and the comparing circuit is arranged for generating an output signal of the pixel sensor according to the ramp signal and the charge signal.

2. The image sensor of claim 1, wherein the ramp signal generating circuit transmits the ramp signal via the ramp signal line.

3. The image sensor of claim 1, wherein each pixel sensor in the pixel sensor array is coupled to one column line via a floating diffusion of the pixel sensor.

4. The image sensor of claim 3, wherein the floating diffusion of each pixel sensor forms a parasitic capacitor.

5. The image sensor of claim 4, wherein during the operating cycle of the readout circuit, each of the comparing circuit is reset before the pixel sensor outputs a charge signal to its floating diffusion of a corresponding column line.

6. The image sensor of claim 5, wherein during each operating cycle of the readout circuit, the pixel sensor transfers the charge signal to its floating diffusion before the ramp signal generating circuit generates the ramp signal.

7. The image sensor of claim 1, wherein each pixel column has a plurality of column lines, and the comparing circuit comprises:
a comparator, for generating the output signal of the pixel sensor coupled to the corresponding column line; and
a switch, for selectively coupling the corresponding column line, selected from the column lines of a corresponding pixel column, to the comparator.

8. The image sensor of claim 1, wherein the ramp signal with a same waveform is assigned to a plurality of pixel rows of the pixel sensor array.

9. The image sensor of claim 1, further comprising:
a plurality of counters, coupled to the comparing circuit, wherein each of the counters is arranged for counting a time period of the ramp signal, and generating a readout value of the pixel sensor according to the output signal and the counted time period.
